(19) United States
(12) Patent Application Publication
(10) Pub. No.: US 2010/0064625 A1
(43) Pub. Date: Mar. 18, 2010

(54) DOOR LITE FRAME SYSTEM

(76) Inventors: Thomas J. Charlton, Camano Island, WA (US); Frank Ross Murray, Bellevue, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/210,111

(22) Filed: Sep. 12, 2008

(51) Int. Cl. E06B 3/96

(52) U.S. Cl. 52/656.4; 52/745.2

(57) ABSTRACT

An improved frame assembly is provided, such as for a window or door frame assembly often referred to as a “door lite.” The improved frame assembly includes an integrally formed cooperative structure of interlocking members having a temporary transport alignment and an installation alignment. Significantly, the cooperative structure includes an alignment guide that engages in both the temporary transport alignment and installation alignment, and also includes an adjustable locking mechanism that engages in the installation alignment, wherein the adjustable locking mechanism can accommodate varying thicknesses of door lites.

### BACKGROUND

1. Technical Field

An improved frame assembly is provided, such as for a window or door frame assembly, which is often referred to as a “door lite.” The improved frame assembly has a component structure that provides an alignment guide for placing two halves of the frame assembly together during transport and final assembly. The improved frame assembly also has a robust and adjustable locking mechanism.

2. Description of the Related Art

Frame assemblies for door lites are generally known in the art. These frame assemblies are typically pre-manufactured in several pieces and shipped to another destination for assembly. For example, door lite frame assemblies can come in two sub-parts, which are secured together with a piece of glass or other transparent or insulating material, such as a glazing panel, in-between the two sub-parts. There are many existing frame assemblies having different types of external clips or other external fasteners (such as screws) for securing the frame assembly together.

Unfortunately, installation of these existing door lite frames with external fasteners can be time consuming. For example, in prior art door lite frames, when the frame assembly arrives at the place of installation, the frame sub-parts typically are separated by removing fasteners that held the sub-parts together during transportation. Then during installation, the frame sub-parts are positioned and resecured together with fasteners. Each fastener that needs to be removed after shipment and resecured during installation, decreasing the efficiency of installation and increases costs.

Another drawback to the existing door lite frames is that any fasteners, or holes for the fasteners, that are visible from the exterior of the door lite can detract from its aesthetic appeal. Covering the visible ends of the fasteners or holes with a plug or putty, for example, requires additional costs and introduces more inefficiency during installation.

An example of a prior art door lite frame assembly is shown in FIG. 1. The prior art door lite 1 has two frame sub-parts 2 and 3 that secure there-between a piece of glass 8. When installed, threaded fasteners 5 are screwed into the threaded holes 6 and 7, securing the glass 8 between the frame sub-parts 2 and 3.

This prior art door lite 1 is not desirable for several reasons. For example, the door lite 1 does not have an efficient and simple way to be aligned or secured during transport from the manufacturing facility to the place of final installation. While the frame sub-parts 2 and 3 can be aligned and secured together with the threaded fasteners 5 before transport, this is undesirable because of the time involved securing the door lite 1 prior to transport, removing the threaded fasteners 5 at the place of installation, and then resecuring the threaded fasteners 5 during final installation. Moreover, the exposed holes 6 and 7 are undesirable.

Door lites without external threaded fasteners have been the subject of U.S. patents, but these door lites suffer from their own problems. For example, a “screwless” door lite is disclosed in U.S. Pat. No. 6,925,767 by Krochmal et al. and U.S. Pat. No. 7,010,888 by Tumlin et al., however these designs do not provide for a shipping orientation or integral parts necessary for alignment in a shipping orientation. Not having a shipping orientation that provides guided interconnection of matching frame assembly sub-parts is a major drawback to these designs. It is desirable to have two matching frame parts aligned together during shipping because this helps ensure that matching parts are transported and delivered together, and it allows a glass panel or glazing to be held in-between the matching frame parts during shipping.

Door lites with shipping and installation orientations have also been the subject of U.S. patents, but these door lites also suffer from their own shortcomings. For example, the door lites disclosed in U.S. Pat. No. 6,694,701 by Wang et al. and U.S. Pat. No. 7,386,959 by Ouellette are inadequate because neither provide for a guided interconnection of matching frame assembly sub-parts in both the shipping and installation orientations via parts formed on the door lite frame.

Rather, Ouellette describes clip structures that are separate components from the door lite frame, thus adding to the cost of manufacturing and increasing the complexity of installation. Similarly, the frame disclosed by Wang et al. suffers from multiple deficiencies. While the frame of Wang et al. provides a shipping and installation orientation, there is no provision for guided interconnection in the installation orientation, leading to misalignment during installation. Moreover, the frame of Wang et al. requires separate structures for orienting the frame during shipping and permanently coupling the frame halves together. These separate structures increase the manufacturing cost and multiply the complications for properly orienting the frame halves during shipping and installation.

Existing door lite frames with an installation alignment system have also proven difficult and cumbersome. For example, U.S. Pat. No. 7,331,142 by Gerard describes a connector system for the shipping and installation orientations, but the alignment system is inadequate and does not provide for minimization of localized torsion that can lead to misalignment during installation and permanent interconnection. The frame disclosed by Gerard is therefore difficult to properly align during installation, leading to problems from the frame halves being permanently connected out of alignment.

Moreover, many of the prior door lites, such as those disclosed by Gerard, Ouellette and Wang et al., do not provide interconnects that acceptably accommodate a wide range of varying thicknesses in the structure sandwiched between the two halves of the frame structure. For example, the two subparts of a door lite frame assembly typically need to be installed on outside portions of a door or frame that is supposed to be 1¾ inches, but the thickness of the door or frame may vary by as much as 0.06 to 0.09 inches. This variance is complicated by differences in thicknesses of other materials and structures that are often placed between the door lite frame and the structure therebetween, for example foam, seals or other gaskets, and panels such as glass or glazing.

Another complication during installation from inadequate provisions for thickness variations is that the door lite frame halves have inadequate connection and retention. For example, in the prior door lites, it is difficult to discern if all of the interconnects are properly connected. Due to the variances in thicknesses in the door lite materials, the opportunity of an improper connection during installation is magnified. Thus, these prior door lite frames may unintentionally separate and come apart after installation.

There is a need for a door lite frame system that provides an adjustable interconnect that can handle variations in thicknesses around the door lite frame. There is also a need for the door lite frame system to provide an alignment structure that is used in both shipping and installation orientations and can also minimize torsion and rotation during installation. Moreover, it is highly desirable for that frame system to be durable and easy to assemble. It is also desirable for that system to have a low cost production with the frame system providing a structure that is easily assembled both in the shipping and installation orientation. No prior art door lite frame system provides all of these desired features.

### BRIEF SUMMARY

In embodiments of the present frame system, some to all of the aforementioned problems are overcome. For example, in certain embodiments, a frame assembly is provided that has orientation structures that substantially axially align in a geometrically congruent fashion two frame halves, with the orientation structures aligning the frame system in both a shipment and an installation orientation. In some embodiments, the orientation structures are configured to provide removable engagement in a shipping orientation so that the frame halves can be quickly and easily decoupled at the place of installation.

Moreover, the orientation structures are configured to provide, in embodiments, a rotational stiffness that substantially holds the two frame halves in alignment and substantially prevents axial rotation of the two frame halves out of alignment. Significantly, in some embodiments, even a single pair of orientation structures, including an orientation guide or pin on one frame half and an orientation receiver or aperture on the other frame half, provide this alignment and rotational stiffness.

Also, in certain embodiments of the present frame system, an interlocking structure is provided that is configured for progressive locking during installation that can accommodate various sizes of materials that may be installed between the two halves of the frame system. Thus, in embodiments having the progressive locking feature, various sizes of material, for example doors, walls, glass, glazing or other materials of substantially different thicknesses, can be installed within the same size framing system without having to change the dimensions of the framing system.

Significantly, in some embodiments, the orientation structures and the interlocking structures work in cooperation to provide a frame system that is robust and easy to align, assemble, and install. For example, the orientation structures cooperate to help ensure that the interlocking structures are aligned and actually lock together during installation, even for embodiments where only one pair of orientation structures is provided.

Also, in embodiments, interaction between the orientation structures and the interlocking structures provides added strength to the frame system. For example, even in embodiments where the orientation structures are separate and distinct from the interlocking structures, rotational stiffness from the orientation structures substantially prevents the two frame halves from axially rotating and the interlocking structures from slipping out of a locked interaction. Moreover, the orientation structures can be configured to absorb forces placed on the frame halves, thereby reducing any stress, force and torque that may act on the interlocking structures.

For example, in some embodiments, a frame assembly is provided that comprises a first frame structure with corresponding first interlocking members and first alignment members substantially parallel to each other and aligned in substantially a same plane. Also, in embodiments, a second frame structure is also provided that has second alignment members each having at least one second interlocking member formed thereon. In these embodiments, the first and second frame structures have a shipping and installation orientations with respect to one another separated by approximately 180 degrees, with the first and second alignment members configured to be engaged in both orientations. In the shipping orientation, the first and second alignment members are configured to be removably engaged, and in the installation orientation, are configured to be substantially permanently engaged by corresponding sets of first interlocking members and second interlocking members. In these embodiments, alignment in both the shipping and installation orientation is provided by the second alignment members each having an aperture that is substantially geometrically congruent with a shape of each of the first alignment members. Thus, even for embodiments having a single set of first and second alignment members, the frame system is aligned during shipping and installation.

These and many other embodiments of the present frame system are provided for and described in the accompanying drawings, detailed description, and claims. Moreover, methods of manufacturing the frame system as well as methods of assembling the frame system in the shipping and installation orientations are provided for and described in the accompanying drawings, detailed description, and claims.

### BRIEF DESCRIPTION OF THE SEVERAL VIEWS OF THE DRAWINGS

FIG. 1 is an isometric view of a prior art frame system;

FIG. 2 is an isometric view of an unassembled embodiment of the present frame system;

FIG. 3 is an isometric view of an embodiment of the present frame system assembled in an installation orientation;

FIG. 4 is an isometric view of a portion of FIG. 3 showing engaged alignment and locking mechanisms;

FIG. 5 is a side view of an embodiment of the present frame system in the installation orientation;

FIG. 6 is a side view of a portion of an embodiment of the present frame system in the installation orientation showing details of alignment and locking between the first and second halves with an embodiment of a progressive locking feature in a first locked position;

FIG. 7 is a cross-sectional view of FIG. 6;

FIG. 8 is a side view of a portion of an embodiment of the present frame system in the installation orientation showing details of alignment and locking between the first and second halves with an embodiment of a progressive locking feature in a second locked position;

FIG. 9 is a cross-sectional view of FIG. 8;

FIG. 10 is a side view of a portion of an embodiment of the present frame system in the installation orientation showing details of alignment and locking between the first and second halves with an embodiment of a progressive locking feature in a third locked position;

FIG. 11 is a cross-sectional view of FIG. 10;

FIG. 12 is a side view of an embodiment of the present frame system in a shipping orientation;

FIG. 13 is a side view of an embodiment of the present frame system in a shipping orientation showing details of alignment between the first and second halves;

FIG. 14 is a side view of an embodiment of a frame half of the present frame system showing orientation receivers and locking structures formed thereon;

FIG. 15 is an isometric view of an embodiment of a frame half of the present frame system showing orientation receivers and locking structures formed thereon;

FIG. 16 is bottom view of an embodiment of a frame half of the present frame system showing orientation receivers and locking structures formed thereon;

FIG. 17 is an isometric view of an embodiment of a frame half of the present frame system showing orientation guides and locking structures formed thereon;

FIG. 18 is a side view of an embodiment of a frame half of the present frame system showing orientation guides and locking structures formed thereon;

FIGS. 19A-19D are isometric views of alternative embodiments of the present frame system showing orientation guides, orientation receivers and locking structures formed thereon; and

FIG. 20 is a block diagram of methods of manufacturing and assembly of various embodiments of the present frame system.

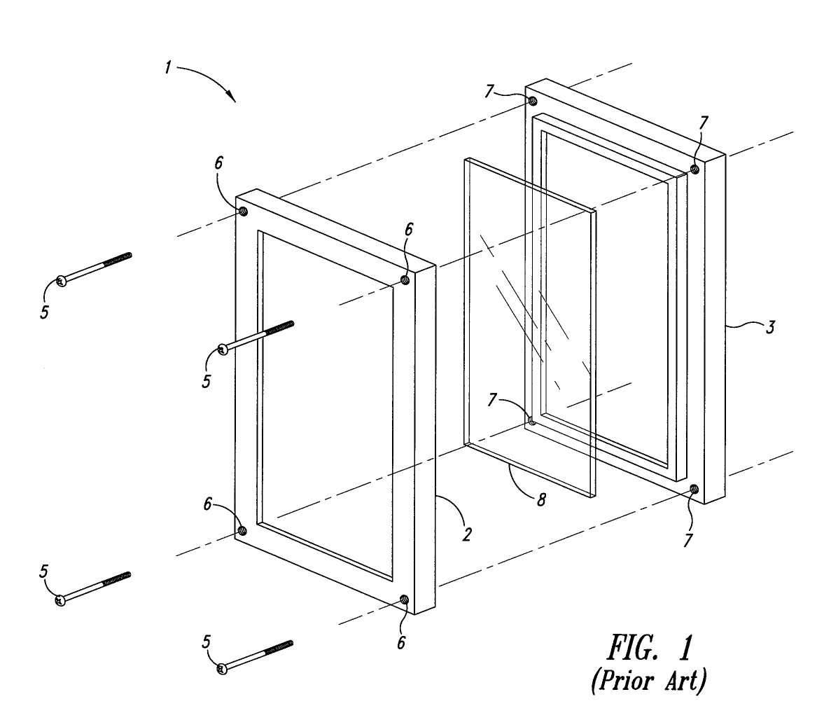

### DETAILED DESCRIPTION

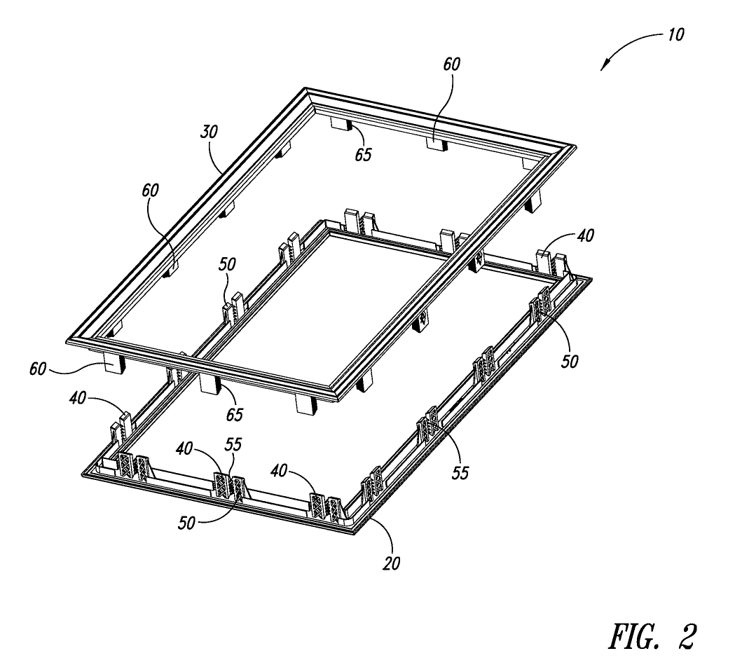

Referring to FIGS. 2-4, an embodiment of a frame system or frame assembly is illustrated. In FIG. 2, an exemplary frame system 10 is shown unassembled in two parts or halves, with a first frame member 20 below a second frame member 30. In an exemplary embodiment, the frame system 10 has a rectangular shape with a plurality of diametrically opposed straight sides. In other embodiments, the frame system 10 and frame halves 20/30 can be substantially larger or smaller than the illustrated structure and can have other shapes, such as other rectangular, oblong, elliptical, square, circular, or triangular shapes or a combination of shapes.

The frame system 10 and the first and second frame halves 20/30, including all of the elements formed thereon, can be formed using known techniques, such as injection molding. Pliable materials, such as Acrylonitrile Butadiene Styrene (ABS), other plastics, or other pliable materials can be used to make the frame system 10. Alternatively, rigid materials, such as nylon, metal, glass or other rigid materials, can be used to make the frame system 10. In other embodiments, the frame system 10 can be made of multiple materials, including combinations of pliable and rigid materials.

In an exemplary embodiment, the first half 20 of the frame structure has a first alignment member and a first interlocking member. For example, in embodiments, first half 20 of the frame structure has an orientation guide 40 and a first locking structure 50 that are each a longitudinally projecting member formed on an inner portion of the first half 20. In embodiments, the first locking structure 50 and the orientation guide 40 are separate and distinct structures spaced apart from one another, as depicted in FIG. 2 (or FIG. 18). In other embodiments, the first locking structure 50 and the orientation guide 40 can be formed together as one piece. Also, in embodiments, one or more of the orientation guides 40 and first locking structures 50 can be formed apart from the first half 20 of the frame system 10 and attached thereto.

In embodiments, the first locking structure 50 includes at least one ledge or arm 55 laterally extending from and formed on a portion of the first locking structure 50. In embodiments, there are a plurality of ledges or arms 55 formed on the first locking structure 50. In an exemplary embodiment, the arms 55 are formed on only one side of the first locking structure 50. In embodiments, the arms 55 laterally project from the first locking structures 50 at an angle, such as 45 degrees.

In embodiments, there are a plurality of orientation guides 40 and a plurality of first locking structures 50 formed on the inner portion of the first frame member 20 and are separate components spaced apart from one another. One orientation guide 40 and one first locking structure 50 form a unit, with the orientation guide 40 and first locking structure 50 separate and distinct from one another but spaced proximately to one another. In embodiments, corresponding orientation guides 40 and first locking structures 50 are formed substantially parallel to one another and project from the first frame member 20 in substantially parallel planes. For each unit, the arms 55 laterally project into a space between the orientation guide 40 and first locking structure 50. In embodiments, the orientation guides 40 and first locking structures are spaced evenly about an inner portion of the first half 20 of the frame system 10.

In an exemplary embodiment, the second half 30 of the frame structure has a second alignment member and a second interlocking member. For example, in embodiments, the second half 30 of the frame structure 10 comprises an orientation receiver 60 that is a longitudinally projecting member formed on an inner portion of the second half 30, with the orientation receiver 60 comprising a second locking structure 65 formed on an outer portion of the orientation receiver 60. In other embodiments, one or more of the orientation receivers 60 and second locking structure 65 can be formed apart from the second half 30 of the frame system 10 and attached thereto.

In embodiments, the second locking structure 65 is at least one lateral projection or ledge, for example, an arm or other structure, or a plurality of such structures, such as a saw-tooth structure or serrated teeth. In this embodiment, there are a plurality of orientation receivers 60, each having a second locking structure 65 formed thereon, and the orientation receivers 60 are spaced evenly about an inner portion of the second half 30 of the frame system 10. In embodiments, the second locking structures 65 are a plurality of triangular saw tooth ledges extending from the side of the orientation receivers 60 with a flat top surface and an angled bottom surface, for example 45 degrees.

Although the frame assembly 10 is shown in embodiments having two frame halves 20/30 with different structures on each half, in alternative embodiments, the two frame halves can be similar or substantially identical. For example, instead of having the orientation guides 40 and first locking structures 50 only on the first frame half 20 and the orientation receivers 60 and second locking structures 65 only on the second frame half 30, these various elements can be placed on both frame halves 20/30 providing identical frame halves 20/30. In these alternative embodiments, the orientation guides 40 can be configured with corresponding orientation receivers 60 and the first locking structures 50 can be configured with corresponding second locking structures 65 to provide guided alignment of the two frame halves 20/30 for shipping and installation orientations and to provide interlocking of the first and second locking structures 50/65 during installation.

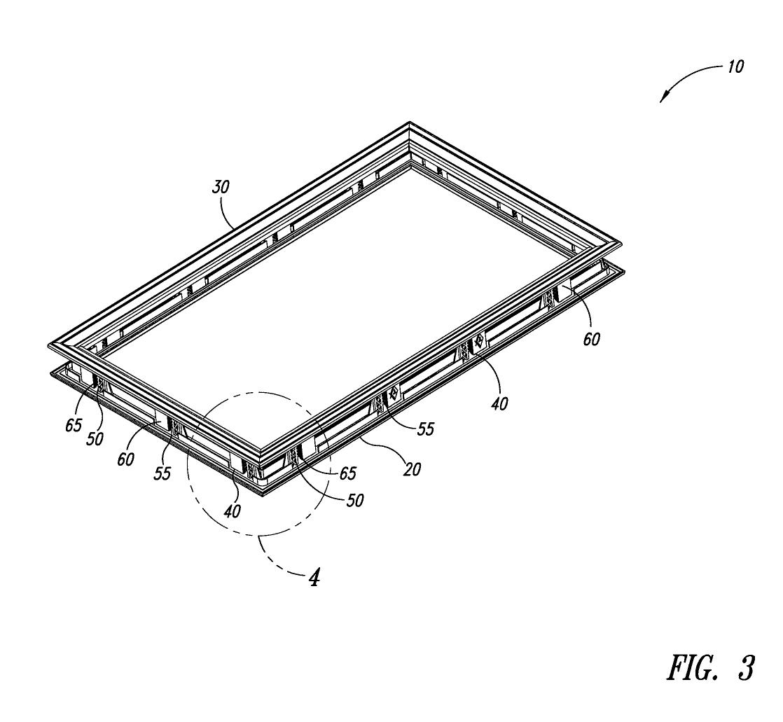

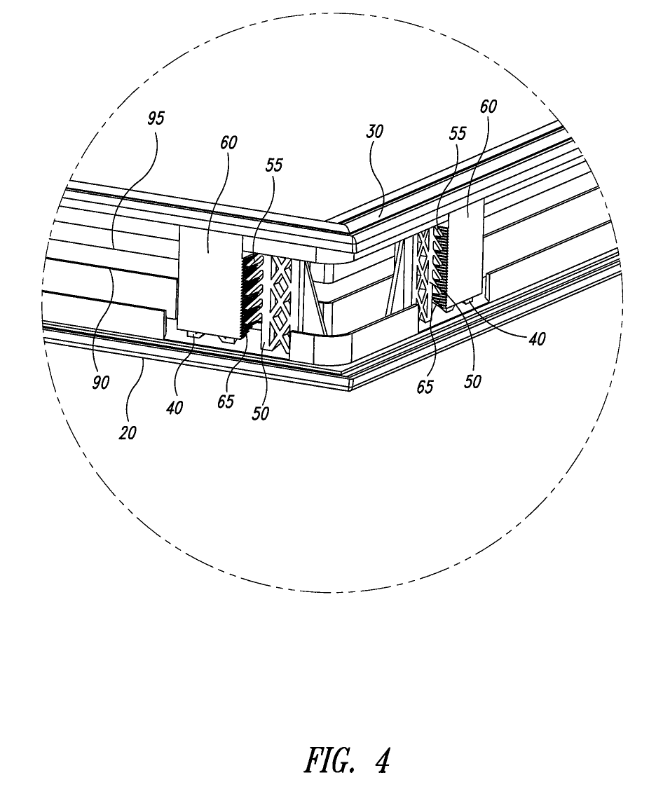

Referring to FIGS. 3-4, an embodiment of the frame assembly 10 is shown in an installation orientation with the orientation guides 40 engaged with the orientation receivers 60 and the first locking structures 50 engaged with the second locking structures 65. In certain embodiments, orientation guides 40 and orientation receivers 60 are means for aligning the first and second frame halves 20/30 during installation. In certain embodiments, the first locking structures 50 and the second locking structures 65 are means for coupling the first and second frame halves 20/30 during installation.

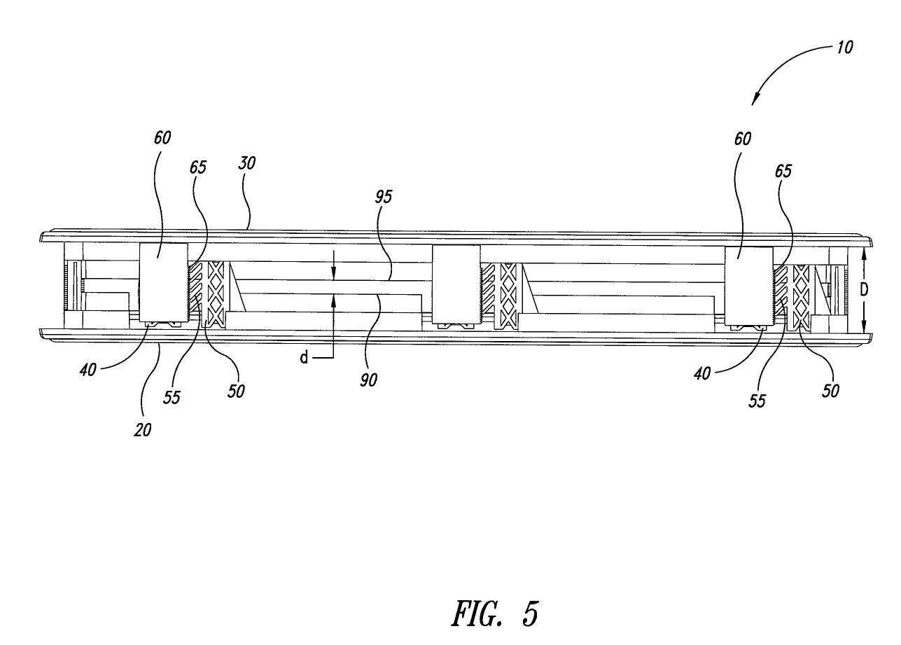

FIG. 4 shows in greater detail the engagement of the orientation guides and receivers 40/60 and first and second locking structures 50/65. When the first and second locking structures 50/65 are engaged and the first and second halves 20/30 of the frame 10 are locked together, a piece of material, such as glass or glazing, can be held in place between an inner surface 90 of the first half 20 and an inner surface 95 of the second half 30. The distance between the surfaces 90/95 is reflected in FIG. 5 by “d”, while the corresponding spacing about the perimeter of the frame 10, where the frame sandwiches a door or other structure, is designated by “D”.

With reference to FIGS. 5-11, engagement of the orientation guides and receivers 40/60 and first and second locking structures 50/65 will be explained in greater detail. FIG. 5 shows a side view of the frame system 10 with the first and second halves 20/30 engaged in an installation orientation. In certain embodiments, the first and second locking structures 50/65 are configured to provide a progressive locking mechanism wherein the first and second halves 20/30 are able to be locked together in an increasingly closer relationship.

Significantly, in embodiments having the first and second locking structures 50/65, the progressive locking mechanism allows materials of various thicknesses to be installed between the same two frame halves 20/30 without having to change the dimensions of the first and second locking structures 50/65. In some embodiments, the progressive locking feature is provided in part by a plurality of laterally extending arms 55 formed lengthwise on a portion of the first locking structure 50 that engage a plurality of second locking structures 65 formed lengthwise on a portion of the orientation receiver 60.

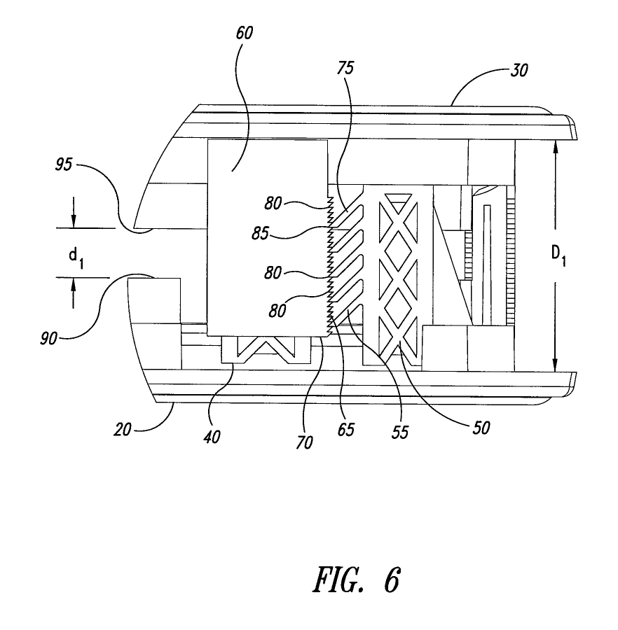

For example, engagement of the orientation guides and receivers 40/60 and first and second locking structures 50/65 is shown in a progressive manner in FIGS. 6-11. In FIG. 6, the first and second halves 20/30 of the frame system are brought together, with the orientation guide 40 inserted into the orientation receiver 60, thereby aligning the second locking structures 65 on the orientation guide 60 to be in substantially the same plane as the arms 55 on the first locking structure 50 before the arms 55 of the first locking structure 50 engage the second locking structure 65 on the orientation guide 60. As the first and second halves 20/30 of the frame system are pushed together, a leading edge 70 of the orientation receiver 60 reaches a proximate edge 85 of a first arm 75, pushing the first arm 75 down until it snaps into a crevice 80 of the second locking structure nearest the leading edge 70 of the orientation receiver 60, thereby substantially permanently coupling or engaging the first and second frame members 20/30. Then, as the first and second halves 20/30 of the frame system are pushed further together, the first and second locking structures 50/65 continue to engage and progressively lock or ratchet, with the arms 55 of the first locking structure 50 locking or ratcheting into crevices 80 of the second locking structure 65.

In embodiments, the arms 55 of the first locking structure 50 are made of a material that allows the arms 55 to deflect as they are engaged by the second locking structures 65, and also allows the arms 55 to snap back into or close to their original orientation as the arms 55 snap into the crevices 80 of second locking structures 65. In alternative embodiments, the arms 55 can be made of a more resilient material and the second locking structures 65 can be made of a material that deflects when engaged by the arms 55, which allows the second locking structures 65 to snap back into their original orientation as the second locking structures 65 lock with the arms 55.

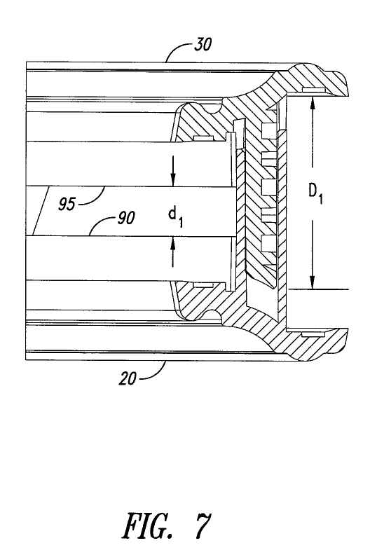

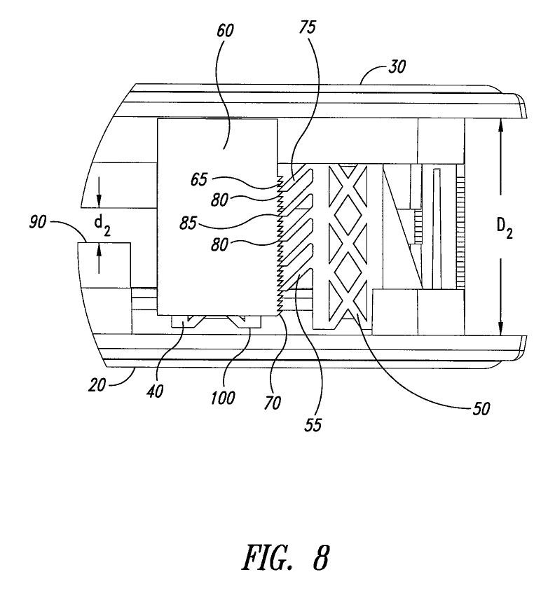

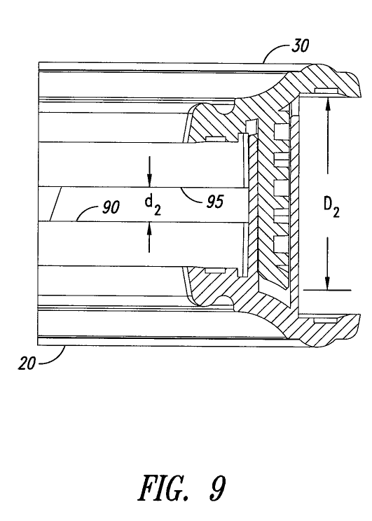

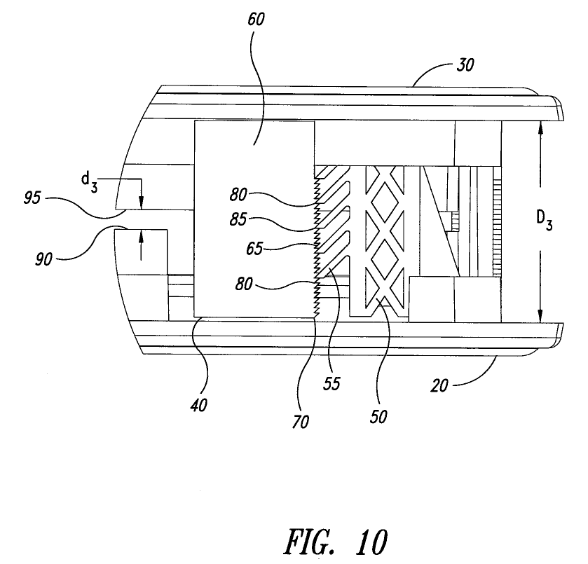

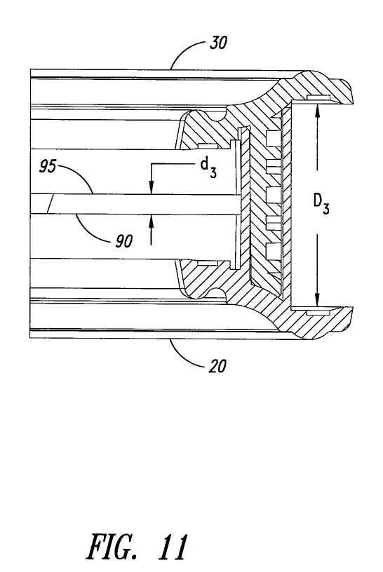

As shown in FIG. 6, the first and second halves 20/30 of the frame system have been pushed together such that each of the arms 55 of the first locking structure 50 are in a crevice 80 of the second locking structure 65. FIG. 7 is a cross-section of FIG. 6, both showing a first distance d₁ between the inner surfaces 90/95 (and a corresponding distance D₁) of the respective frame halves 20/30. FIG. 8 illustrates the first and second halves 20/30 of the frame system pushed together even further, with the leading edge 70 of the orientation receiver 60 proximate a distal end 100 of the orientation guide 40. FIG. 9 is a cross-section of FIG. 8, both showing a second distance d₂/D₂ closer than the first distance d₁/D₁ between the respective frame halves 20/30. FIG. 10 illustrates the first and second halves 20/30 of the frame system pushed together even further, with the leading edge 70 of the orientation receiver 60 reaching substantially a same plane as a distal end 100 of the orientation guide 40. FIG. 11 is a cross-section of FIG. 10, both showing a third distance d₃/D₃ closer than the second distance d₂/D₂ between the respective frame halves 20/30.

As can be appreciated from the progressive locking feature illustrated in FIGS. 5-11, which can progressively decrease a distance between the first and second halves 20/30 of the frame system, the first and second halves 20/30 of the frame system can be locked together with a varying range of distance between the first half 20 and the second half 30. This range of distance provided by the progressive locking feature allows for various widths or sizes of material that can be placed between the inner surface 90 of the first half 20 and the inner surface 95 of the second half 30 of the frame system, and can likewise accommodate for door or other structures of varying thicknesses.

Referring to FIGS. 2-4 and 12-13, an embodiment of the present frame system 10 having a shipping and installation orientations will be discussed. An installation orientation of an embodiment of the frame system is shown in FIGS. 2-4, with the first half 20 and second half 30 of the frame system 10 aligned such that when the two frame halves 20/30 are brought together, the orientation guides 40 engage the orientation receivers 60. In embodiments, the orientation guides 40 have a greater height than the arms 55 of the first locking structure 50 so that the orientation guides 40 engage the orientation receivers 60 before the arms 55 of the first locking structure 50 engage the second locking structure 65 on the orientation receiver 60. As a result, the interaction between the orientation guides 40 and the orientation receivers 60 helps ensure that the two frame halves 20/30 are properly aligned for installation prior to locking of the frame halves 20/30 together, with the outside perimeters of the first and second halves 20/30 of the frame assembly being substantially congruent. Once the geometry of the frame halves are properly aligned via the orientation guides 40 entering the orientation receivers 60, the frame halves 20/30 can be pressed together, with the orientation guides 40 continuing to travel up into the orientation receivers 60, and the first and second locking structures 50/65 engaging one another and substantially permanently locking the two frame halves together.

For shipping, however, it is desirable for the frame halves 20/30 to not be permanently locked together. Rather, it is desirable for the frame halves 20/30 to be easily separated just prior to installation. Also, it is desirable for the frame halves 20/30 to be aligned during shipment to keep matching frame halves 20/30 together and provide an efficient use of space during shipment, as well as to allow materials to be stored between the frame halves 20/30 during shipment. In certain embodiments, orientation guides 40 and orientation receivers 60 are means for aligning the first and second frame halves 20/30 during shipment.

In embodiments, the frame system 10 provides a shipping orientation by rotating one of the two frame halves 20/30 by 180 degrees axially from the orientation shown in FIGS. 2-4. It can be appreciated, however, that rotation required between the shipping and installation orientations depends on the particular shape of the frame system 10 and frame halves 20/30. For example, in embodiments where the frame system 10 or frame halves 20/30 have more than two axes of symmetry, such as circular, hexagonal, or square shapes, then rotation between shipping and installation orientations can be 90 degrees or less. In contrast, when the frame system 10 and frame halves 20/30 have only two axes of symmetry, such as an oblong, rectangle or elliptical shapes, then rotation between shipping and installation orientations will be 180 degrees.

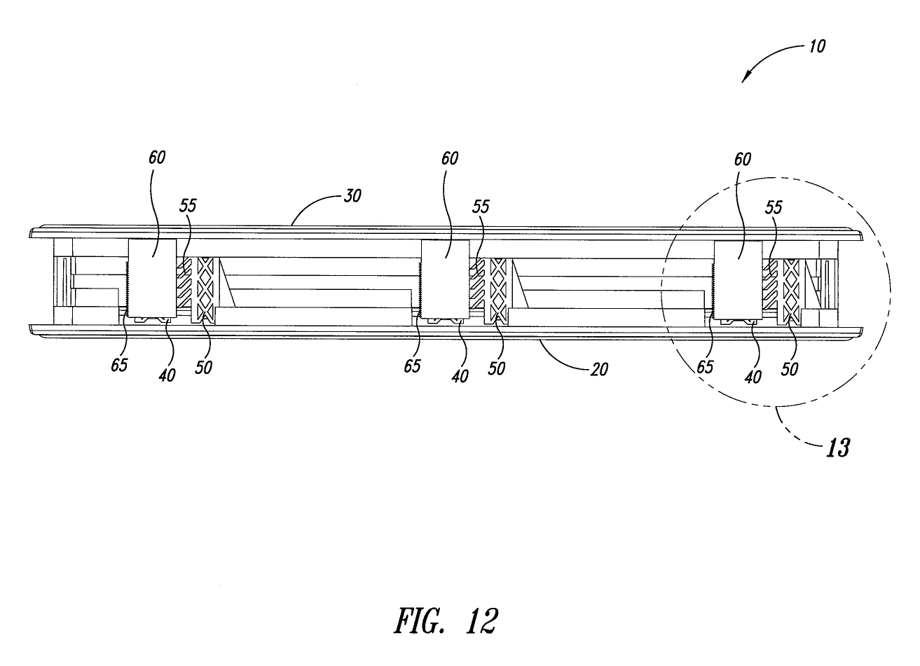

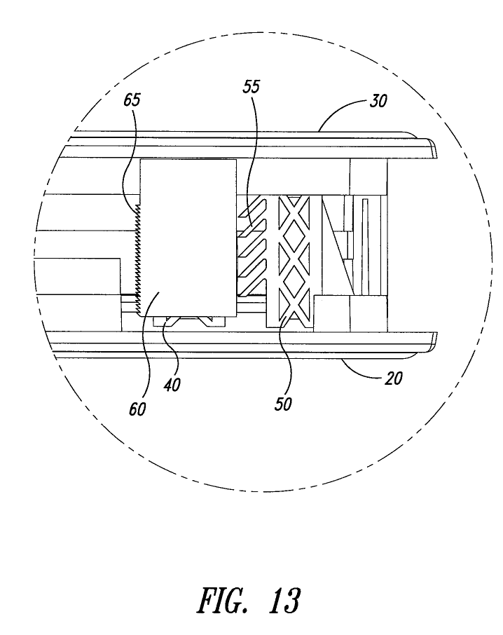

Similar to the installation orientation, the orientation guides 40 and receivers 60 provide a guide to align the frame halves together in certain embodiments. In the shipping orientation, as shown in FIGS. 12-13, the frame system 10 is aligned through engagement of the orientation guides 40 and orientation receivers 60, while the second locking structures 65 do not engage the first locking structures 50. Instead, the orientation guides 40 enter and engage the orientation receivers 60, thereby providing alignment of the frame halves 20/30 during shipping with the outside perimeters of the first and second halves 20/30 of the frame assembly 10 being substantially congruent.

In embodiments, the orientation guides 40 and orientation receivers 60 are geometrically shaped such that when they engage one another, they are removably received or removably engaged. For example, in embodiments, a friction fit is provided between the orientation guides 40 and orientation receivers 60 when they are engaged. Thus, the friction fit between the orientation guides 40 and orientation receivers 60 hold the frame halves 20/30 together. The friction fit is also configured to be quickly and efficiently disengaged without having to release a locking structure. In alternative embodiments, however, the orientation guides 40 and orientation receivers 60 can be provided with a locking device or structure or wrapping material to provide greater strength in holding the frame halves 20/30 together during shipment.

In the embodiment shown in FIGS. 12-13, the second locking structures 65 do not engage the first locking structures 50 in the shipping orientation because the second locking structures 65 are formed on one side of the orientation receiver 60. The second locking structures 65 on the orientation receivers 60 are configured to be aligned and engage with the first locking structure when in the installation orientation (shown in FIG. 2), and in contrast, when one of the frame halves 20/30 is rotated 180 degrees axially, for example clockwise or counter-clockwise in a plane parallel with the installation orientation, until the frame halves are in a shipping orientation (shown in FIGS. 12-13).

In embodiments, one or both of the frame halves 20/30 can include fasteners, either as part of or separate from the frame system, to secure the frame halves together during shipping. For example, the frame halves 20/30 can be secured together with a fastener or wrapped with tape or plastic or a shipping material to hold the frame halves 20/30 together in the shipping orientation. Also, the orientation guides 40 and receivers 60 can be shaped such that when the guides 40 engage the receivers 60, there is a friction fit holding the frame halves 20/30 together in the shipping orientation.

Embodiments of the orientation receiver 60 and second locking structure 65 will be discussed with reference to FIGS. 14-16. In an embodiment, the orientation receivers 60 are formed on an inside portion of one of the two halves 20/30 of the frame system 10 with the orientation receivers evenly spaced around the frame half. In alternative embodiments, however, the orientation receivers 60 can be formed on the other frame half 20, or alternatively, the orientation receivers 60 can be formed on both of the frame halves 20/30. Moreover, in embodiments, the orientation receivers 60 can be unevenly spaced around one or more of the frame halves 20/30, and the second locking structures 65 can be formed on only a portion of the total number of orientation receivers 60, for example, on every other orientation receiver 60 or some other random or systematic selection.

As shown in FIG. 14, in embodiments, the second engagement structures 65 are formed on the orientation receiver 60 such that when the frame halves 20/30 are aligned in the installation orientation (shown in FIGS. 2-4), the second locking structures 65 face the first locking structures 50 (i.e., the second locking structures 65 and the first locking structures face each other) and are therefore axially aligned with and capable of engaging each other when the orientation guide 40 is inserted and pushed into the orientation receiver 60. In contrast, when one of the frame halves 20/30 is axially rotated 180 degrees with respect to the other, the second engagement structures 65 do not face the first locking structures 50 (i.e., the second locking structures 65 and the first locking structures face the same direction) and therefore not engage each other when the orientation guide 40 is inserted and pushed into the orientation receiver 60, as shown in FIGS. 12-13.

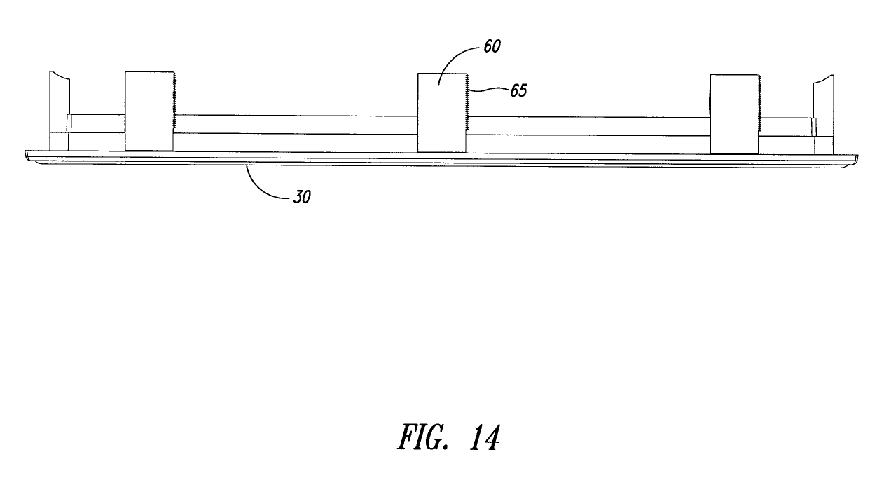

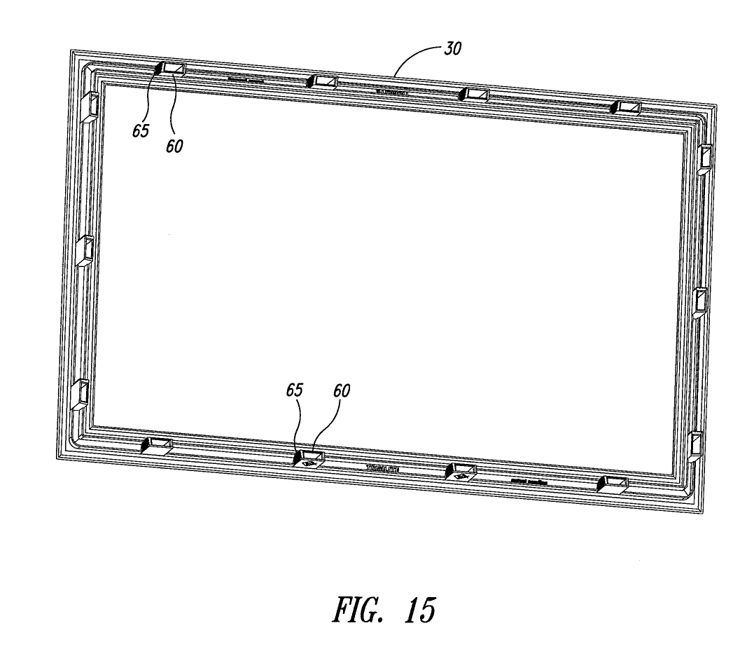

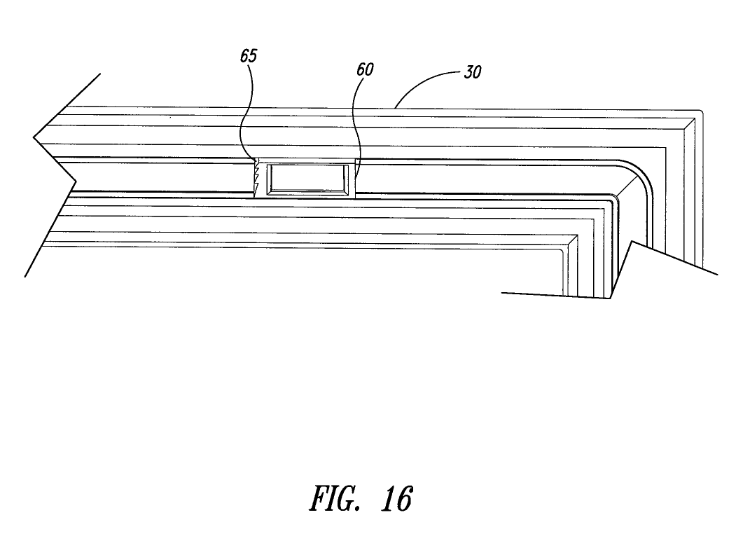

With reference to FIGS. 15-16, in embodiments, the orientation receivers 60 each define a closed rectangular cavity, with the second locking structures 65 formed on only one side of each orientation receiver 60. In alternative embodiments, the orientation receiver 60 can be other shapes, for example other rectangular, oblong, elliptical, square, circular, or triangular shapes or a combination of shapes. In alternative embodiments, the second locking structures 65 can be formed on more than one side of the orientation receiver 60 or can be absent from the orientation receiver 60. In alternative embodiments, the orientation receiver 60 and second locking structures 65 can be separate structures formed on the same or different halves 20/30 of the frame system.

Referring to FIGS. 6 and 16, in embodiments, the second locking structures 65 are a plurality of ridges formed on the orientation receiver 60, where the ridges are configured to engage and provide a locking fit with at least a portion of the first locking structure 50. In alternative embodiments, the second locking structures 65 can be any number of structures, such as another ledge, arm or saw tooth or a different structure having one or more segments configured to engage and lock with at least a portion of the first locking structure 50.

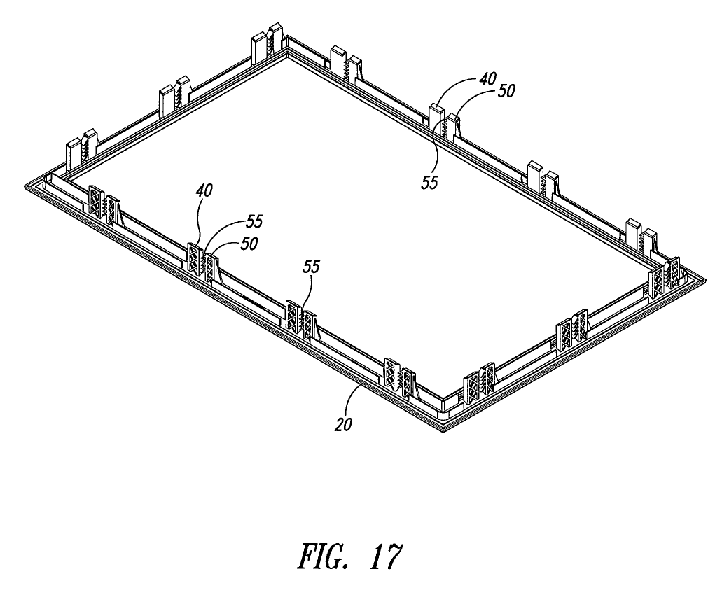

Embodiments of the orientation guide 60 and first locking structure 50 having arms 55 will be discussed with reference to FIGS. 17-18. In an embodiment, the orientation guides 40 and first locking structures 50 are formed on an inside portion of one of the two halves 20/30 of the frame system 10 with the orientation guides 40 and first locking structures 50 formed separately, evenly spaced around the frame half 20 in corresponding pairs. In alternative embodiments, however, the orientation guides 40 and first locking structures 50 can be formed on the other frame half 30, or alternatively, the orientation guides 40 and first locking structures 50 can be formed on separate frame halves 20/30 or on both of the frame halves 20/30. Moreover, in embodiments, either or both of the orientation guides 40 and first locking structures 50 can be unevenly spaced around one or more of the frame halves 20/30, and in embodiments, the arms 55 of the first locking structures 50 can be formed on only a portion of the total number of first locking structures 50, for example, on every other first locking structure 50 or some other random or systematic selection.

As shown in FIG. 18, in embodiments, the arms 55 are formed on the first locking structure 50 such that when the frame halves 20/30 are aligned in the installation orientation (shown in FIGS. 2-4), the arms 55 face the second locking structures 65 (i.e., arms 55 and the second locking structures 65 face each other) and are therefore axially aligned and capable of engaging each other when the orientation guide 40 is inserted and pushed into the orientation receiver 60. In contrast, when one of the frame halves 20/30 is axially rotated 180 degrees, the arms 55 do not face the second engagement structures 65 (i.e., the arms 55 and the second locking structures 65 face the same direction) and are therefore not axially aligned and do not engage each other when the orientation guide 40 is inserted and pushed into the orientation receiver 60, as shown in FIGS. 12-13.

In embodiments, the orientation guides 40 are formed in a geometric shape that is substantially congruent with a geometric shape of an aperture formed within the orientation receivers 60. For example, in embodiments, the orientation guides 40 are each a closed rectangular structure formed on an inner surface of the frame half 20 with the rectangular structure having a rectangular shape substantially similar to the closed rectangular cavity of the orientation receivers 60. In alternative embodiments, the orientation guide 40 and orientation receivers 60 can be other shapes, for example other rectangular, oblong, elliptical, square, circular, or triangular shapes or a combination of shapes. In alternative embodiments, the arms 55 can be formed on more than one side of the first locking structure 50 or can be absent from the first locking structure 50. In alternative embodiments, the arms 55 and first locking structure 50 can be separate structures formed on the same or different halves 20/30 of the frame system.

Referring to FIGS. 6 and 18, in embodiments, the arms 55 are a plurality of ledges formed on the first locking structure 50, where the ledges are configured to engage and provide a locking fit with at least a portion of the second locking structures 65. In alternative embodiments, the arms 55 can be any number of structures, such as another ledge, arm or saw tooth or another structure having one or more segments configured to engage and lock with at least a portion of the second locking structure 65.

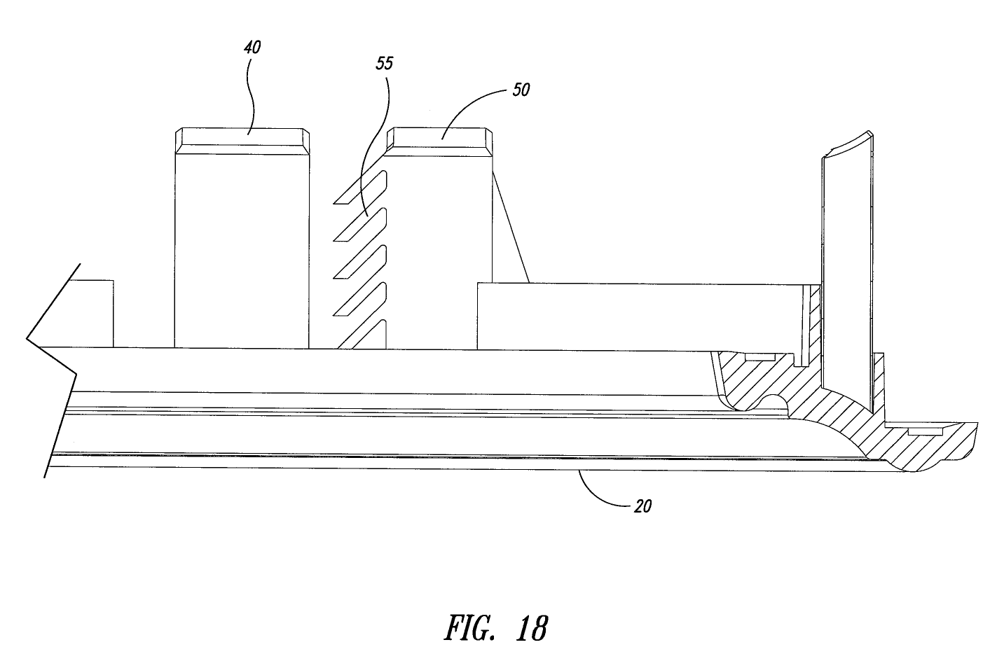

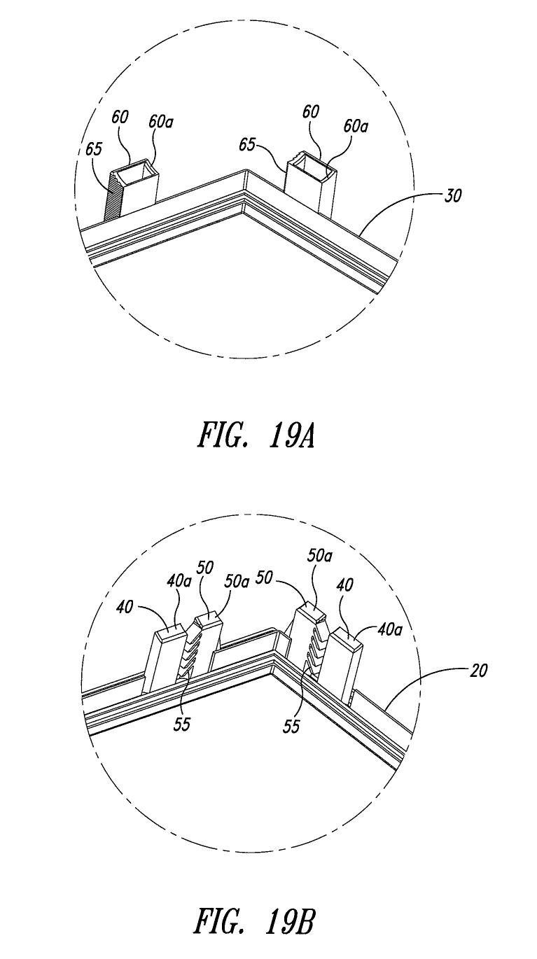

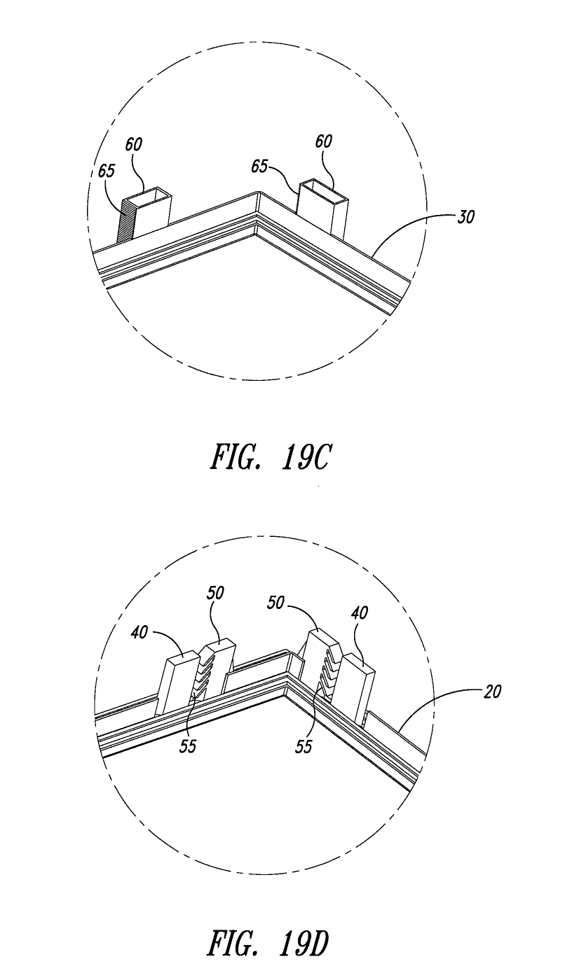

Referring to FIGS. 19A-19D, alternative embodiments of the orientation guide 40, orientation receiver 60, and first and second locking structures 50/65 will be discussed. As shown in FIGS. 19A and 19B, the orientation guides 40 and orientation receivers 60 each have corresponding tapered upper portions 40A and 60A leading to substantially similar rectangular cross-sections beyond the tapered portions. Likewise, in embodiments, the first locking structures 50 have a tapered upper portion 50A. In these embodiments, misalignment or butting of the upper portions of the orientation guides and receivers 40/60 is less likely to occur because the upper tapered portions 40A and 60A have a tapered or curved cross-sectional area at the top for initial engagement, and then have increasing flat corresponding cross-sectional areas as the orientation guides and receivers 40/60 are engaged and aligned together.

In these embodiments, the tapered upper portions 40A and 60A facilitate alignment of the frame halves 20 and 30 in either the shipment or installation orientations. As the frame halves 20 and 30 are brought together, the uppermost tapered portions 40A and 60A of at least one pair of corresponding orientation guides 40 and orientation receivers 60 engage one another, thereby aligning at least a portion of the frame halves 20 and 30, and also allowing some axial rotational movement between the frame halves 20/30.

The axial rotational movement allowed by the engagement of the uppermost tapered portions 40A and 60A facilitates engagement and alignment of other corresponding orientation guides 40 and orientation receivers 60. For example, variations in geometry of materials between the frame halves 20/30 and variations in tolerances of the frame halves 20/30 and their corresponding elements can be accommodated by limited axial rotation movement between the uppermost tapered portions 40A and 60A of engaged orientation guides 40 and orientation receivers 60 until the remaining orientation guides 40 and orientation receivers 60 are aligned and engaged.

In either the shipment or installation orientations, once the orientation guides 40 and orientation receivers 60 have been aligned and engaged by at least their uppermost tapered portions 40A and 60A, the orientation guides 40 and orientation receivers 60 can be pressed together until the orientation guides 40 are received by the orientation receivers 60 beyond the uppermost tapered portions 40A and 60A.

In embodiments, for example, with reference to FIGS. 6-11 and 19A-19B, the tapered upper portion 40A of the orientation guide 40 can be pressed into the corresponding orientation receiver 60 until the tapered upper portion 40A of the orientation guide 40 rests upon a corresponding tapered portion of the second frame half 30. Similarly, the tapered upper portion 60A of the orientation receiver 60 can engage the corresponding orientation guide 40 until the tapered upper portion 60A of the orientation receiver 60 rests upon a corresponding tapered portion of the first frame half 20. In embodiments, where the tapered upper portions 40A/60A of the orientation guides and receivers 40/60 rest upon the frame halves 20/30, the tapered upper portion 50A of the first locking structures can also rest upon a corresponding tapered portion of the second frame half 30.

In alternative embodiments, the upper portions of the orientation guides 40, orientation receivers 60 and the first locking structures 50 can have cross-sectional areas different than that discussed above and depicted in the corresponding Figures. For example, in alternative embodiments depicted in FIGS. 19C and 19D, the upper portions of the orientation guides 40, orientation receivers 60 and the first locking structures 50 are not tapered or curved, but rather each have flat upper portions.

In embodiments, the upper lip of the orientation guides 40, orientation receivers 60 and the first locking structures 50 can be uniform and rectangular, without tapered or curved upper portions, as shown in FIGS. 19C and 19D. In these alternative embodiments, the orientation guides 40 and orientation receivers 60 can still engage one another and align the frame halves in the shipment and installation orientations 20/30, and the first and second locking structures 50/65 can still engage one another in the installation orientation.

In these embodiments depicted in FIGS. 19C and 19D, the frame halves 20/30 can be adapted to have flat portions that correspond to the flat upper cross-sectional area of the orientation guides 40, orientation receivers 60 and the first locking structures 50. Thus, in embodiments, for example, the flat upper portion of the orientation guide 40 can be pressed into the corresponding orientation receiver 60 until the flat upper portion of the orientation guide 40 rests upon a corresponding flat portion of the second frame half 30. Similarly, the flat upper portion of the orientation receiver 60 can engage the corresponding orientation guide 40 until the flat upper portion of the orientation receiver 60 rests upon a corresponding flat portion of the first frame half 20. In embodiments where the flat upper portions of the orientation guides and receivers 40/60 rest upon the frame halves 20/30, the flat upper portion of the first locking structures 50 can also rest upon a corresponding flat portion of the second frame half 30.

In other embodiments, the frame halves 20/30 can be configured with one or more of the orientation guides 40, orientation receivers 60, and first and second locking structures 50/65 depicted in FIGS. 19A-19D. For example, in embodiments, a frame system can include orientation guides 40, orientation receivers 60, and first locking structures 50 both with tapered or curved upper ends and flat, non-tapered upper ends.

In embodiments having at least one half of the frame system with an orientation receiver defining a cavity having at least one flat portion, for example orientation receiver 60, the orientation receiver can engage a corresponding orientation structure on the other half of the frame system, for example orientation guide 40, or other orientation structures with a shape substantially similar to the shape of the orientation receiver's cavity or aperture. When the orientation receiver and corresponding flat outer portion(s) of the orientation guide engage each other, interaction between the flat inner portion(s) of the orientation receiver and corresponding flat outer portions of the orientation guide provide for alignment between the orientation receiver and orientation guide, and as a result, alignment between the first and second halves of the frame system. Thus, alignment between the first and second halves of the frame system can be provided for by a single orientation receiver on one frame half and a single orientation guide on the other frame half.

In embodiments having orientation receivers 60 and orientation guides 40, it can be appreciated that once one pair of a corresponding orientation receiver 60 and guide 40 engage each other, the entire frame system 10 will be aligned in either the shipping orientation or the installation orientation.

Significantly, this relationship provides assurances during installation that when the orientation receivers 60 and orientation guides 40 are aligned, each of the first and second locking structures 50/65 will properly engage and substantially lock the two frame halves 20/30 together in proper alignment. Similarly, during shipment, when the orientation receivers 60 and orientation guides 40 are aligned, the frame halves 20/30 will be brought and held together in proper alignment in the shipping orientation.

In certain embodiments, interaction between the orientation guides 40 and orientation receivers 60 during alignment also restricts axial rotational movement between the two frame halves, resulting in a rotational stiffness with the first and second frame structures 20/30 being substantially rotationally fixed. For example, engagement of a single orientation guide 40 and orientation receiver 60 can substantially restrict the axial rotational movement of the two frame halves 20/30 from the flat surfaces of the orientation guide 40 and orientation receiver 60 pushing against each other. Accordingly, engagement of a single pair of a corresponding orientation guide 40 and orientation receiver 60 can result in both frame halves 20/30 being properly aligned, and moreover, can result in the frame halves 20/30 being substantially rotationally fixed, with axial rotational movement between the frame halves 20/30 being minimized or eliminated. In preferred embodiments, there are a plurality of orientation guides 40, orientation receivers 60, and first and second locking structures 50/65 to maximize the strength, flexibility, and ease of orientation and installation of the frame system.

Significantly, the added rotational stiffness from the orientation guides 40 and orientation receivers 60 provides added strength when the two frame halves 20/30 are in an installation orientation and the first and second locking structures 50/65 are engaged. Thus, in some embodiments, even though the orientation guide 40 is separate and distinct from the first and second locking structures 50/65, the rotational stiffness from the orientation guides 40 and orientation receivers 60 substantially prevents the two frame halves 20/30 from axially rotating and the first and second locking structures 50/65 from slipping out of a locked interaction. Moreover, the first and second locking structures 50/65 can absorb forces placed on the frame halves 20/30, thereby reducing any stress, force and torque that may act on the first and second locking structures 50/65.

In embodiments having the progressive locking features provided by the first and second locking structures 50/65, it can also be appreciated that as each arm 55 engages the second locking structures 65, a greater force would be required to separate the two frame halves 20/30. Accordingly, in these embodiments of the frame system 10, flexibility is provided as to the force required to separate the two frame halves 20/30 once substantially permanently locked together in an installation orientation.

In certain embodiments, the interaction of the progressive locking mechanism of the first and second locking structures 50/65 along with the added rotational stiffness from the orientation guides 40 and orientation receivers 60 provides a significant improvement over other frame systems. For example, in tests of the first and second locking structures 50/65 and orientation guides 40 and orientation receivers 60, there was a 50% greater strength than the locking features of the door lite frame described in U.S. Pat. No. 6,694,701.

In an exemplary embodiment, the frame assembly has two rectangular halves, forming a 15″×25″ door lite. First alignment members and first interlocking members are spaced equally around an inside perimeter of one of the frame halves, with spacing between adjacent first alignment members and first interlocking members being between approximately 25-28 mm, and the spacing between adjacent first alignment members and between adjacent first interlocking members being between approximately 150-160 mm. These dimensions and configurations are provided as an example only. One of ordinary skill in the art can use the present frame assembly and select dimensions and configurations appropriate for specific applications. Moreover, specific dimensions of the alignment and interlocking structures are dependant on the specific application and materials used. Thus, it is within the ordinary skill in the art to optimize particular dimensions for particular applications using the disclosed frame system.

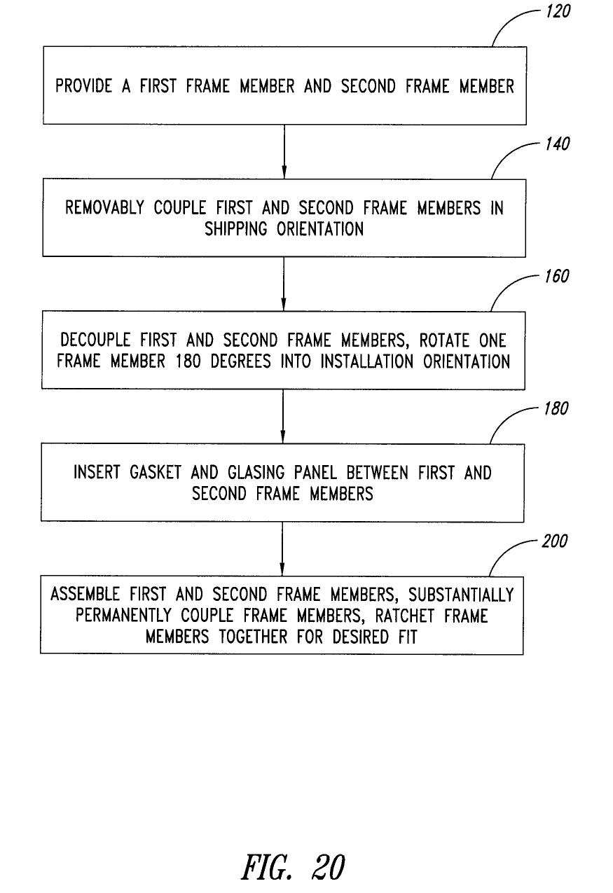

Referring to FIG. 20, and referencing embodiments found in FIGS. 2-19D, methods of manufacturing and assembling frame systems are described. For example, in embodiments, a frame system can be manufactured by the step 120 of providing a first frame member and a second frame member, for example first and second halves 20 and 30 of the frame system 10. In an exemplary embodiment, the first frame member comprises one or more first longitudinally extending members for alignment, for example an orientation guide 40, and one or more second longitudinally extending members having one or more ledges for interlocking, for example a first locking structure 50 with arms 55. In an embodiment, one or more of the ledges of a second longitudinally extending member is within a space between corresponding first and second longitudinally extending members of the first frame member. In an exemplary embodiment, the second frame member comprises one or more third longitudinally extending members, for example orientation receiver 60, having an aperture for alignment with a shape corresponding to the shape of the first longitudinally extending member and one or more ledges for interlocking, for example second locking structure 65, formed on an outside portion of the third longitudinally extending member.

In embodiments, the frame system is manufactured in such a way as to provide the first and second frame members that are configured for a first shipping orientation, where at least one of the longitudinally extending members are able to be removably received by the apertures of at least one of the third longitudinally extending members. In the shipping orientation, the received first longitudinally extending members are substantially rotationally fixed to the corresponding third longitudinally extending members. Also, the frame system is manufactured to provide for a second installation orientation, where at least one of the first longitudinally extending members are received by the apertures of at least one of the third longitudinally extending members. In the installation orientation, at least one of the first set of ledges of the second longitudinally extending members engage at least one of the second set of ledges of the third longitudinally extending members, thereby substantially permanently coupling the received first longitudinally extending members and the corresponding third longitudinally extending members. In embodiments, the first and second orientations are approximately a 180 degree rotation from each other. Also, the frame assembly can be configured such that the first and second sets of ledges are only engaged in the installation orientation.

In some embodiments, the frame assembly is manufactured and configured to provide a frame assembly where at least one of the first and third longitudinally extending members are engaged in both the first and second orientations. This provides alignment of the frame system, with the outside perimeters of the first and second frame members being substantially congruent, in both the first and second orientations.

Once the frame assembly is manufactured, it can be assembled for shipment and for installation. For example, in embodiments, the first and second frame members provided in step 120 can be assembled for shipment by performing a step 140 of removably coupling the first and second frame members in a shipping orientation, with at least one of the first longitudinally extending members, for example orientation guide 40, removably received within an aperture of at least one of the third longitudinally extending members, for example orientation receiver 60, thereby substantially rotationally fixing the first and second frame members in a substantially geometric congruent alignment. In some embodiments, a panel, for example a piece of glass or glazing, can be inserted between the first and second frame members prior to the step 140 of removably coupling the frame members.

After shipping the frame assembly, a method of installation can be performed. For example, in embodiments, a step 160 of decoupling the first and second frame members from the shipment orientation is performed by removing at least one of the first longitudinally extending members from the aperture of at least one of the third longitudinally extending members, followed by rotating at least one of the first and second frame members approximately 180 degrees into an installation orientation. Then, a step 180 of inserting a gasket and a panel, for example glass or glazing, between the two frame members is performed. For example, placing the gasket and panel on an inside portion of one or more of the two frame members. The two frame members can then be assembled from opposing sides of a door or other structure by performing a step 200 of having at least one of the first longitudinally extending members, for example orientation guide 40, received by at least one aperture of a third longitudinally extending member, for example orientation receiver 60, such that at least one ledge of a second longitudinally extending member, for example first locking structure 50 and arm 55, engage at least one ledge of a third longitudinally extending member, for example second locking structure 65 and orientation receiver 60, thereby substantially permanently coupling the received first longitudinally extending member and the corresponding third longitudinally extending member. The two frame members can then be ratcheted together, via progressive engagement of the first and second sets of ledges, by pushing the two frame members together until a desired fit between the two frame members and the panel, door and/or other structures therebetween is achieved.

With respect to the various methods described, it is understood that other steps, techniques, configurations, components and processes are contemplated without departing from the subject matter contemplated herein. Moreover, while the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

These and other changes can be made to the embodiments in lite of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A frame assembly comprising:
a first frame member defining a first frame member plane, the first frame member comprising
a plurality of first longitudinally extending members each projecting from the first frame member in a direction at least substantially normal to the first frame member plane and each having a cross-section with a geometric shape,
a plurality of second longitudinally extending members each projecting from the first frame member in a direction at least substantially normal to the first frame member plane and each having a first set of ledges formed thereon,
wherein corresponding first set of ledges are within a space between corresponding first and second longitudinally extending members of the first frame member; and
a second frame member defining a second frame member plane, the second frame member comprising
a plurality of third longitudinally extending members
each projecting from the second frame member in a direction at least substantially normal to the second frame member plane and
each having an aperture formed therein, the aperture having a geometric shape that is substantially the same as the plurality of first longitudinally extending members, and
a plurality of second sets of ledges formed on an outside portion of each of the third longitudinally extending members,
wherein the frame assembly is configured such that
when the first and second frame members are in a first orientation, at least a portion of the plurality of first longitudinally extending members are removably received by the apertures of at least a portion of the plurality of third longitudinally extending members such that the received first longitudinally extending members are substantially rotationally fixed to the corresponding third longitudinally extending members, and
when the first and second frame members are in a second orientation, at least a portion of the first longitudinally extending members are received by the apertures of at least a portion of the third longitudinally extending members and at least a portion of the first sets of ledges of the second longitudinally extending members engage at least a portion of the second sets of ledges of the third longitudinally extending members, thereby substantially permanently coupling the received first longitudinally extending members and the corresponding third longitudinally extending members.

2. The frame assembly of claim 1, wherein the frame assembly is configured such that at least a portion of the first and third longitudinally extending members are engaged in both the first and second orientations, and wherein the engaged first and third longitudinally extending members are configured to provide alignment such that an outside perimeter of both the first and second frame members are substantially congruent in both the first and second orientations.

3. The frame assembly of claim 1, wherein the frame assembly is configured such that at least one of the first and second frame members is displaced approximately 180 degrees between the first orientation and the second orientation.

4. The frame assembly of claim 1, wherein the frame assembly is configured such that when in the first orientation, the first and second sets of ledges are not engaged.

5. The frame assembly of claim 1, wherein the frame assembly is a door lite installed in a door.

6. The frame assembly of claim 1, wherein at least one of the first, second, and third longitudinally extending members has a tapered upper portion.

7. A method of assembling a frame for shipment, the method comprising:
providing a first frame member defining a first frame member plane, the first frame member comprising
a plurality of first longitudinally extending members
each projecting from the first frame member in a direction at least substantially normal to the first frame member plane and
each having cross section with a geometric shape,
a plurality of second longitudinally extending members
each projecting from the first frame member in a direction at least substantially normal to the first frame member plane and
each having a first set of ledges formed thereon,
wherein corresponding first set of ledges are within a space between corresponding first and second longitudinally extending members of the first frame member;
providing a second frame member defining a second frame member plane, the second frame member comprising a plurality of third longitudinally extending members
each projecting from the second frame member in a direction at least substantially normal to the second frame member plane and
each having an aperture formed therein, the aperture having a geometric shape that is substantially the same as the plurality of first longitudinally extending members, and
a plurality of second sets of ledges formed on an outside portion of each of the third longitudinally extending members; and
assembling the first and second frame members such that at least a portion of the first longitudinally extending members are removably received by the apertures of at least a portion of the third longitudinally extending members such that the received first longitudinally extending members are substantially rotationally fixed to the corresponding third longitudinally extending members.

8. The method of claim 7, wherein during the assembling step, the first and second sets of ledges are not engaged.

9. The method of claim 7, further comprising the step of inserting a panel between the first and second frame members prior to the step of assembling the first and second frame members.

10. The method of claim 9, wherein the panel is a piece of glazing.

11. The method of claim 9, wherein the panel is a piece of glass.

12. The method of claim 7, further comprising the step of securing the first and second frame members together after the assembling step.

13. The method of claim 7, wherein the frame is a door lite configured to be installed in a door.

14. The method of claim 7, wherein at least one of the first, second, and third longitudinally extending members has a tapered upper portion.

15. A method of installing a frame assembly, the method comprising:
providing a first frame member defining a first frame member plane, the first frame member comprising
a plurality of first longitudinally extending members
each projecting in a plane normal to the first frame member plane and
each having a geometric shape,
a plurality of second longitudinally extending members
each projecting in a plane normal to the first frame member plane and
each having a first set of ledges formed thereon,
wherein corresponding first set of ledges are within a space between corresponding first and second longitudinally extending members of the first frame member;
providing a second frame member defining a second frame member plane, the second frame member comprising
a plurality of third longitudinally extending members
each projecting in a plane normal to the second frame member plane, and
each having an aperture formed therein, the aperture having a geometric shape that is substantially the same as the plurality of first longitudinally extending members, and
a plurality of second sets of ledges formed on an outside portion of each of the third longitudinally extending members; and
assembling the first and second frame members such that at least a portion of the first longitudinally extending members are received by the apertures of at least a portion of the third longitudinally extending members such that the first sets of ledges of at least a portion of the plurality of second longitudinally extending members engage the second sets of ledges of the portion of third longitudinally extending members, thereby substantially permanently coupling the received first longitudinally extending members and the corresponding third longitudinally extending members.

16. The method of claim 15, the method further comprising, prior to the assembling step, a step of removing at least a portion of the first longitudinally extending members from the apertures of at least a portion of the third longitudinally extending members.

17. The method of claim 16, the method further comprising, after the step of removing at least a portion of the first longitudinally extending members from the apertures of at least a portion of the third longitudinally extending members, a step of rotating at least one of the first and second frame members approximately 180 degrees.

18. The method of claim 16, the method further comprising, prior to the assembling step, a step of inserting a panel between the first and second frame members.

19. The method of claim 18, the method further comprising, after the step of inserting the panel, a step of ratcheting each of the engaged first and second sets of ledges, thereby tightening a fit between the first and second frame members and the panel therebetween.

20. The method of claim 19, the method further comprising, prior to the assembling step, a step of inserting a gasket along a perimeter of at least one of the first and second frame members.

21. The method of claim 20, wherein the panel is a piece of glazing.

22. The method of claim 20, wherein the panel is a piece of glass.

23. The method of claim 15, wherein the frame assembly is a door lite configured to be installed in a door.

24. The method of claim 15, wherein at least one of the first, second, and third longitudinally extending members has a tapered upper portion

25. A method of manufacturing a frame assembly, the method comprising:
providing a first frame member defining a first frame member plane, the first frame member comprising
a plurality of first longitudinally extending members
each projecting in a plane normal to the first frame member plane and
each having a geometric shape,
a plurality of second longitudinally extending members
each projecting in a plane normal to the first frame member plane and
each having a first set of ledges formed thereon,
wherein corresponding first set of ledges are within a space between corresponding first and second longitudinally extending members of the first frame member; and
providing a second frame member defining a second frame member plane, the second frame member comprising
a plurality of third longitudinally extending members
each projecting in a plane normal to the second frame member plane and
each having an aperture formed therein, the aperture having a geometric shape that is substantially the same as the plurality of first longitudinally extending members, and
a plurality of second sets of ledges formed on an outside portion of each of the third longitudinally extending members,
wherein the frame assembly is configured such that
in a first orientation, at least a portion of the plurality of first longitudinally extending members are removably received by the apertures of at least a portion of the plurality of third longitudinally extending members such that the received first longitudinally extending members are substantially rotationally fixed to the corresponding third longitudinally extending members, and
in a second orientation, at least a portion of the first longitudinally extending members are received by the apertures of at least a portion of the third longitudinally extending members such that at least a portion of the first sets of ledges of the second longitudinally extending members engage at least a portion of the second sets of ledges of the third longitudinally extending members, thereby substantially permanently coupling the received first longitudinally extending members and the corresponding third longitudinally extending members.

26. The method of claim 25, wherein the frame assembly is configured such that at least a portion of the first and third longitudinally extending members are engaged in both the first and second orientations, and wherein the engaged first and third longitudinally extending members are configured to provide alignment such that an outside perimeter of both the first and second frame members are substantially congruent in both the first and second orientations.

27. The method of claim 25, wherein the frame assembly is configured such that at least one of the first and second frame members is rotated approximately 180 degrees between the first orientation and the second orientation.

28. The method of claim 25, wherein the frame assembly is configured such that when in the first orientation, the first and second sets of ledges are not engaged.

29. The method of claim 25, wherein the frame assembly is a door lite configured to be installed in a door.

30. The method of claim 25, wherein at least one of the first, second, and third longitudinally extending members has a tapered upper portion

31. A frame assembly comprising:
a first frame structure comprising a plurality of corresponding sets of first interlocking members and first alignment members, wherein each set of first interlocking members and first alignment members are at least substantially aligned with each other; and
a second frame structure comprising a plurality of second alignment members, each of the second alignment members having a second interlocking member formed thereon,
wherein the first and second frame structures are configured to have at least two orientations with respect to one another, each of the at least two orientations separate by approximately 180 degrees,
wherein the plurality of first and second alignment members are configured to be engaged in both the at least two orientations of the first and second frame structures.

32. The frame assembly of claim 31, wherein the plurality of second alignment members each comprises an aperture that is substantially geometrically congruent with a shape of each of the plurality of first alignment members.

33. The frame assembly of claim 32, wherein the frame assembly is configured such that when in one of the two orientations, the plurality of first and second alignment members are configured to be removably engaged.

34. The frame assembly of claim 33, wherein the frame assembly is configured such that when in one of the two orientations, the plurality of first and second alignment members are configured to be substantially permanently engaged by corresponding sets of first interlocking members and second interlocking members.

35. A frame assembly comprising:
means for aligning a set of first and second frame members during shipment;
means for aligning the set of first and second frame members during installation; and
means for coupling the set of first and second frame members during installation.

36. The frame assembly of claim 35, wherein the means for aligning the set of first and second frame members during shipment comprises a plurality of longitudinally extending members on the first frame member and a plurality of apertures extending from the second frame member, wherein the longitudinally extending members and apertures have substantially the same geometric shape such that the longitudinally extending members can be inserted into the apertures.

37. The frame assembly of claim 36, wherein the means for aligning the set of first and second frame members during installation comprises the plurality of longitudinally extending members on the first frame member and the plurality of apertures extending from the second frame member.

38. The frame assembly of claim 37, wherein the means for coupling the set of first and second frame members during installation comprises a first plurality of ledges extending from the first frame member and a second plurality of ledges extending from the second frame member, wherein the first and second plurality of ledges engage one another during installation.

39. The frame assembly of claim 38, wherein the first plurality of ledges are formed on a plurality of second longitudinally extending members on the first frame member, and wherein the second plurality of ledges are formed on an outside portion of the plurality of apertures extending from the second frame member.

40. The frame assembly of claim 39, wherein at least one of the plurality of longitudinally extending members on the first frame member, the plurality of second longitudinally extending members on the first frame member, and the plurality of apertures extending from the second frame member has a tapered upper portion.
